(19) United States
(12) Patent Application Publication
(10) Pub. No.: US 2016/0135135 A1
(43) Pub. Date: May 12, 2016

(54) METHOD AND APPARATUS FOR COMMUNICATION FOR COEXISTING WITH WIRELESS-LAN IN NON-LICENSED BAND

(71) Applicant: Electronics and Telecommunications Research Institute, Daejeon (KR)

(72) Inventors: Sung Jin YOO, Daejeon (KR); Kyu Min KANG, Daejeon (KR); Seung Keun PARK, Daejeon (KR); Jae Cheol PARK, Daejeon (KR); Jung Sun UM, Daejeon (KR)

(21) Appl. No.: 14/937,391

(22) Filed: Nov. 10, 2015

(30) Foreign Application Priority Data
Nov. 11, 2014 (KR) 10-2014-0156283
Oct. 13, 2015 (KR) 10-2015-0142895

(51) Int. Cl. H04W 56/00; H04W 72/04

(52) U.S. Cl. CPC H04W 56/001; H04W 72/0453; H04W 84/12

(57) ABSTRACT

Disclosed is a communication method for coexisting with a non-licensed band communication system of a non-licensed band in a licensed band communication system. The method includes: transmitting a signal by a transmitter in order to operate in a non-licensed band, when the signal is a transmission target signal having frames and a wireless local area network (WLAN) preamble signal is inserted to the front of each frame of the transmission target signal; and extracting the WLAN preamble signal from the signal of the transmitter by a receiver to synchronize with the transmitter.

### CROSS-REFERENCE TO RELATED APPLICATION

This application claims the benefit of priority to Korean Patent Application No. 10-2014-0156283, filed on Nov. 11, 2014, and Korean Patent Application No. 10-2015-0142895, filed on Oct. 13, 2015 in the Korean Intellectual Property Office, the disclosure of which is incorporated herein in its entirety by reference.

### BACKGROUND OF THE INVENTION

1. Field of the Invention

The present disclosure relates to a method and an apparatus for a communication, and more particularly, to a method and an apparatus for a communication for coexisting with a wireless local area network (WLAN), or the like of a non-licensed band in a licensed band such as a long term evolution (LTE) system, or the like.

2. Description of the Related Art

Recently, the standardization of 3GPP has been progressed to use a LTE system in a non-licensed band. In the non-licensed band, many wireless LAN systems are already operated. Therefore, if the LTE system desires to use the non-licensed band, the problem of coexistence with the wireless LAN system that operates in an existing non-licensed band should be solved.

In particular, in the case of the non-licensed band in the vicinity of 5 GHz, the problem of coexistence with a radar system as well as coexistence with the wireless LAN system should also be considered. In the case of the wireless LAN system, a dynamic frequency selection (DFS) function is used in order to co-exist with the radar system. The DFS function refers to a function that moves to other channel to protect a radar signal when detecting the radar signals in a channel that is used by the wireless LAN system.

### SUMMARY OF THE INVENTION

The present disclosure has been made in view of the above problems, and provides a method and an apparatus for a communication that transmits a frame having a WLAN preamble which is inserted in a start section located in front of each frame, in order to coexist with a non-licensed band communication system such as a wireless local area network (WLAN), a radar system, or the like of a non-licensed band in a licensed band communication system such as a long term evolution (LTE) system, or the like.

In accordance with an aspect of the present disclosure, a communication method for coexisting with a non-licensed band communication system of a non-licensed band in a licensed band communication system includes: transmitting a signal by a transmitter in order to operate in a non-licensed band, when the signal is a transmission target signal having frames and a wireless local area network (WLAN) preamble signal is inserted to the front of each frame of the transmission target signal; and extracting the WLAN preamble signal from the signal of the transmitter by a receiver to synchronize with the transmitter. The frame of the transmission target signal includes a long term evolution (LTE) frame. The non-licensed band communication system includes a WLAN system or a radar. The communication method protects from interference caused by a signal of the non-licensed band communication system. The communication method protects a channel shift which is accomplished as the non-licensed band communication system mistakes the transmission target signal for a radar signal in a dynamic frequency selection (DFS) band. Transmitting a signal by the transmitter includes inserting the WLAN preamble so that the WLAN preamble signal is transmitted after an idle period, when the idle period is included between frames of the transmission target signal. A length of the idle period is variably selected with respect to a length between each frame of the transmission target signal. Transmitting a signal by a transmitter includes transmitting a signal to which duration information for effectively receiving a signal during a corresponding time is inserted in addition to the WLAN preamble signal.

In accordance with another aspect of the present disclosure, a communication apparatus for transmitting a transmission target data in a licensed band communication system in order to coexist with a non-licensed band communication system of a non-licensed band includes: a frame signal transmitter configured to generate each frame of a transmission target signal, in order to operate in the non-licensed band; a WLAN signal generator configured to generate an additional signal including a wireless local area network (WLAN) preamble signal; and a time synchronizer configured to control to insert the additional signal to the front of each frame of the transmission target signal. The frame of the transmission target signal includes a long term evolution (LTE) frame. The non-licensed band communication system includes a WLAN system or a radar. An idle period is included between frames of the transmission target signal, and the time synchronizer inserts the WLAN preamble so that the WLAN preamble signal is transmitted after the idle period. A length of the idle period is variably selected with respect to a length between each frame of the transmission target signal. The WLAN signal generator generates the additional signal which further includes duration information for effectively receiving a signal during a corresponding time.

In accordance with another aspect of the present disclosure, a communication apparatus for receiving a signal transmitted from a licensed band communication system in order to coexist with a non-licensed band communication system of a non-licensed band includes: a frame signal receiver configured to extract each frame of a target signal from the transmitted signal, in order to operate in the non-licensed band; and a WLAN signal detector configured to extract an additional signal including a wireless local area network (WLAN) preamble signal which is inserted to front of each frame of the target signal from the transmitted signal, wherein the frame signal receiver is synchronized based on the WLAN preamble signal. The frame of the transmission target signal includes a long term evolution (LTE) frame. The non-licensed band communication system includes a WLAN system or a radar. An idle period is included between frames of the transmission target signal, and the WLAN signal detector extracts the inserted WLAN preamble after the idle period. A length of the idle period is variably selected with respect to a length between each frame of the transmission target signal. The additional signal further includes duration information for effectively receiving a signal during a corresponding time.

### BRIEF DESCRIPTION OF THE DRAWINGS

The objects, features and advantages of the present disclosure will be more apparent from the following detailed description in conjunction with the accompanying drawings, in which:

FIG. 1 is a diagram illustrating an example of interference of a WLAN signal in a typical LTE system;

FIG. 2 is a diagram illustrating an example of a typical WLAN system that accomplishes a channel shift by a LTE signal in a DFS band;

FIG. 3 is a diagram illustrating a structure of a conventional LTE frame;

FIG. 4 is a diagram illustrating a structure of a LTE frame in a communication method according to an embodiment of the present disclosure;

FIG. 5 is a diagram illustrating a structure of another LTE frame in a communication method according to an embodiment of the present disclosure;

FIG. 6A is a diagram illustrating a transmitter structure in a communication system of a licensed band such as LTE for a co-use of a non-licensed band according to an embodiment of the present disclosure;

FIG. 6B is a flowchart illustrating an operation of a transmitter of FIG. 6A;

FIG. 7A is a diagram illustrating a receiver structure in a communication system of a licensed band such as LTE for a co-use of a non-licensed band according to an embodiment of the present disclosure;

FIG. 7B is a flowchart illustrating an operation of a receiver of FIG. 7A; and

FIG. 8 is a diagram illustrating location of a WLAN preamble signal of a communication method according to an embodiment of the present disclosure.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

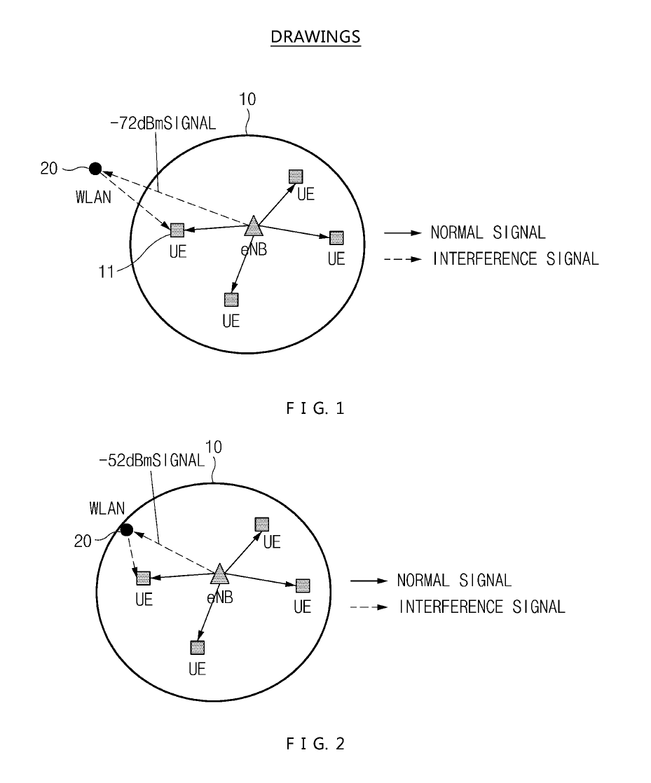

First, a problem related with interference of a WLAN signal in a typical LTE system and a channel shift of a DFS band in a WLAN system is described with reference to FIG. 1 and FIG. 2.

FIG. 1 is a diagram illustrating an example of interference of a WLAN signal in a typical LTE system.

FIG. 1 illustrates an example of a situation in which a LTE system, which supports a mobile communication between an eNB (base station) and a UE (user terminal)(s) within a certain coverage 10 by the eNB, can be interfered by a WLAN system 20 (e.g., WiFi Access Point, or the like), when operating in a non-licensed band in the vicinity of 5 GHz such as WiFi, or the like.

In FIG. 1, the eNB may send a normal signal of the non-licensed band to the UEs serviced by the eNB. In this case, a near WLAN system 20 such as an external of the eNB coverage 10 may receive an eNB signal (e.g., −72 dBm) equal to or lower than a heterogeneous system carrier sensing reference (e.g., −62 dBm).

When receiving the eNB signal (e.g., −72 dBm) equal to or lower than a heterogeneous system carrier sensing reference (e.g., −62 dBm), the WLAN system 20 may ignore the eNB signal and may transmit the data of the WLAN. In this case, the WLAN signal works as interference on a communication signal between a UE 11 around the WLAN system 20 and the eNB and lower the performance of the LTE system using the non-licensed band.

This effect is caused due to the characteristics of the carrier sensing of the WLAN. That is, in the case of the WLAN signal, −82 dBm signal which is lower than a normal energy detection level may be detected by using a preamble, but such a preamble is not transmitted to the typical LTE system.

FIG. 2 is a diagram illustrating an example of a typical WLAN system 20 that accomplishes a channel shift by a LTE signal in a Dynamic Frequency Selection (DFS) band.

FIG. 2 illustrates an example of a situation in which the WLAN system 20 (e.g., WiFi Access Point) accomplishes a channel shift by a LTE signal when a LTE system, which supports a mobile communication between an eNB (base station) and a UE (user terminal)(s) within a certain coverage 10 by the eNB, operates in a non-licensed band in the vicinity of 5 GHz such as WiFi, or the like.

An apparatus, such as the WLAN system 20, that operates in a certain band requiring the DFS function among 5 GHz band should not continue to use a corresponding channel but shift to other channel when receiving a radar signal equal to or higher than the heterogeneous system carrier sensing reference (e.g., −62 dBm).

In FIG. 2, when both the WLAN system 20 and the eNB operate in the same channel that requires the DFS function, the WLAN system 20 may mistake a signal transmitted by the eNB for a radar signal to shift to other channel. In this case, even though the WLAN system 20 and the LTE system may coexist and use the channel simultaneously, there is a problem in that the overall frequency utilization efficiency may be degraded as the WLAN system 20 should shift a channel.

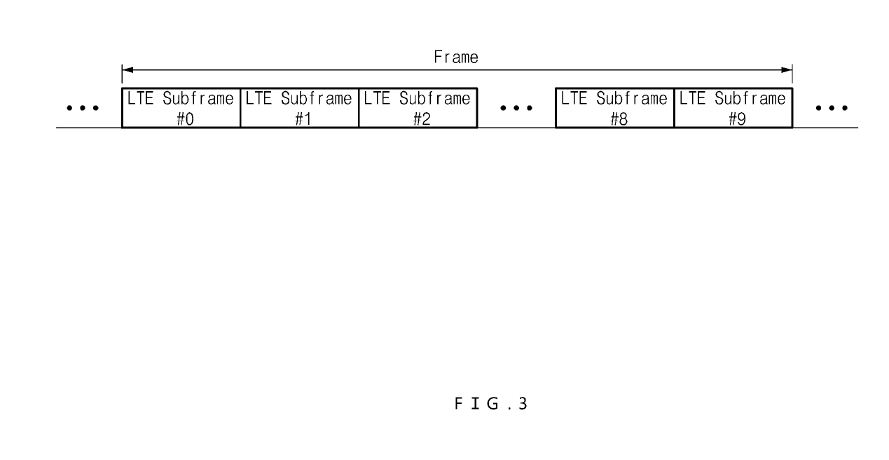

FIG. 3 is a diagram illustrating a structure of a conventional LTE frame. The conventional LTE frame may be configured of 10 sub-frames, and a signal for synchronization may be included in the sub-frame. The LTE system (e.g., eNB, UE, etc.) may repeatedly transmit a transmission signal of each frame unit periodically, but may transmit the frames without a separate preamble.

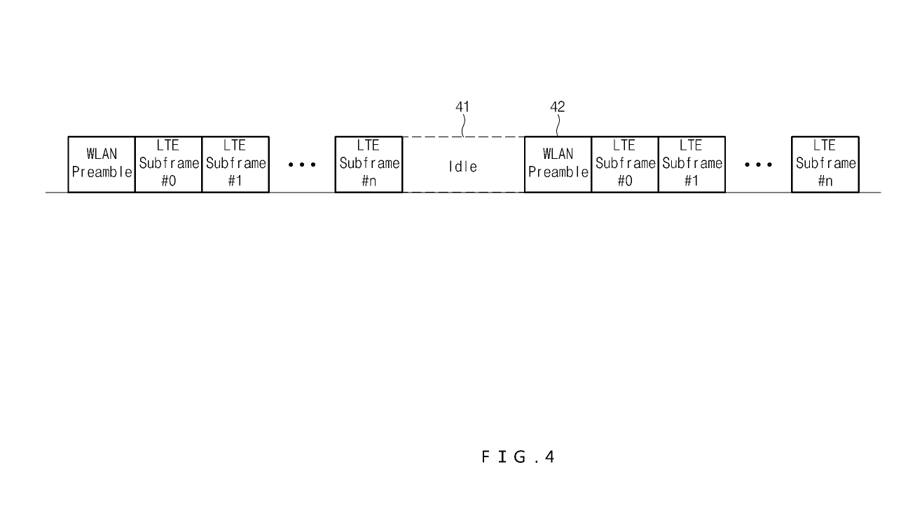

FIG. 4 is a diagram illustrating a structure of a LTE frame in a communication method according to an embodiment of the present disclosure.

When operating in a non-licensed band, the communication system in a licensed band such as the LTE band cannot continue to occupy a channel as it should coexist other system such as a non-licensed band (communication) system, other communication company system, or the like. Thus, as shown in FIG. 4, an idle period exists between frames, and each frame does not operate continuously in time. In addition, in the present disclosure, a WLAN preamble for the synchronization may be transmitted to a start section 42 in front of each frame in a licensed band such as the LTE, or the like. Here, each frame may include n (natural number) (e.g., 10) sub-frames in addition to the WLAN preamble.

As described above, the licensed band communication such as the LTE may be better protected from the WLAN interference, by transmitting and receiving the frame having a start section 42 in front of each frame to which the WLAN preamble is inserted. In addition, in the related art, in the DFS band, the WLAN system may mistake a transmission target signal according to a protocol such as LTE, or the like for the radar signal to shift a channel such that the overall frequency utilization efficiency may be degraded. However, in the present disclosure, as the frame having a start section 42 in front of each frame to which the WLAN preamble is inserted is transmitted and received, such a mistake may be prevented in the DFS band.

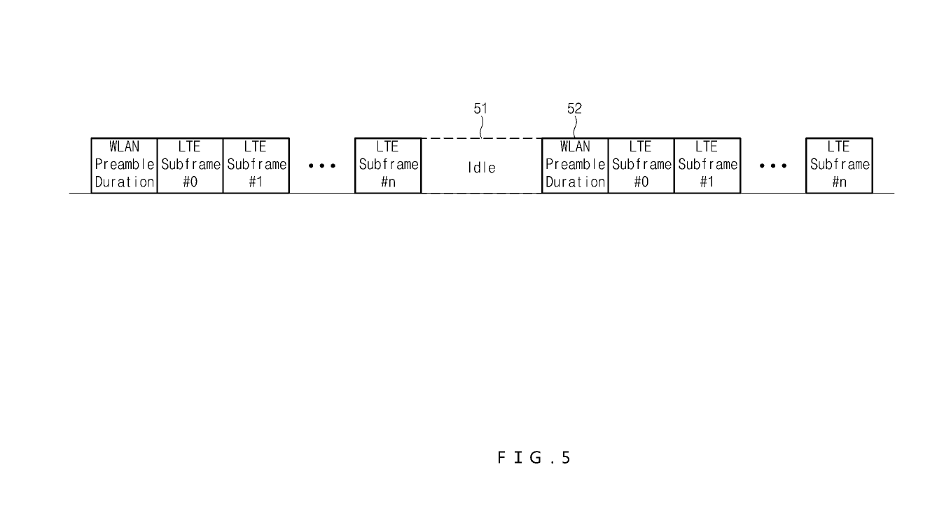

FIG. 5 is a diagram illustrating a structure of another LTE frame in a communication method according to an embodiment of the present disclosure.

Referring to FIG. 5, when transmitting a signal of the LTE or the like, the licensed band communication system such as the LTE or the like simultaneously may transmit the WLAN preamble and reservation time (duration) information in the start section 52 in front of each frame after the idle period 51 between frames such that the interference by which the licensed band communication such as the LTE or the like is affected from the WLAN may be more reduced. Here, each frame may include n (natural number) (e.g., 10) sub-frames in addition to the WLAN preamble.

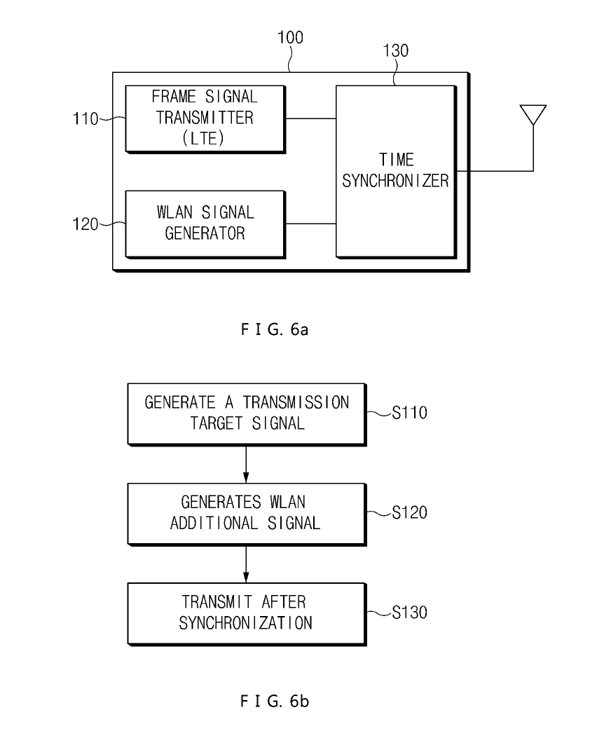

FIG. 6A is a diagram illustrating a transmitter 100 structure in a communication system of a licensed band such as LTE for a co-use of a non-licensed band according to an embodiment of the present disclosure. FIG. 6B is a flowchart illustrating an operation of a transmitter 100 of FIG. 6A.

Referring to FIG. 6A, the transmitter 100 (e.g., eNB, UE, etc.) in a licensed band communication system such as the LTE or the like according to an embodiment of the present disclosure, may include a frame signal transmitter 110, a WLAN signal generator 120, and a time synchronizer 130, in order to transmit a transmission target signal according to protocol such as the LTE through the use of the 5 GHz non-licensed band by co-existing with the non-licensed band communication system (e.g., WiFi Access Point, etc.) such as the WLAN, the radar, or the like.

The frame signal transmitter 110 may generate a transmission target signal according to protocol such as the LTE through a Fast Fourier Transform (FFT) processing with respect to the transmission target data (S110). As shown in FIG. 4 or FIG. 5, each frame of the transmission target signal may include n (natural number) (e.g., 10) sub-frames.

Since it is difficult to share a FFT function block as different FFT algorithms are used with respect to the licensed band such as the LTE, or the like and the non-licensed band such as the WLAN, or the like, the WLAN signal generator 120 may generates an additional signal including a certain WLAN preamble signal through a separate FFT processing (S120). Such an additional signal may include reservation time (duration) information as shown in FIG. 5.

The time synchronizer 130 may synchronize the transmission target signal of the frame signal transmitter 110 with the addition signal of the WLAN signal generator 120, and control to insert the additional signal to the start section (42/52) in front of each frame after the idle period (41/51) between frames of the transmission target signal (S130). The additional signal may include a certain WLAN preamble signal, and may further include reservation time (duration) information. The transmission target signal and the additional signal which are synchronized by the time synchronizer 130 may be transmitted via an antenna after the processing of a power amplifier, or the like.

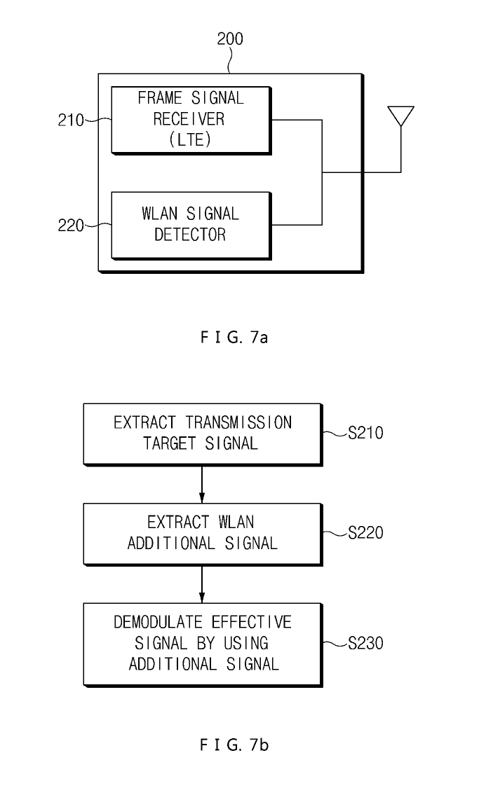

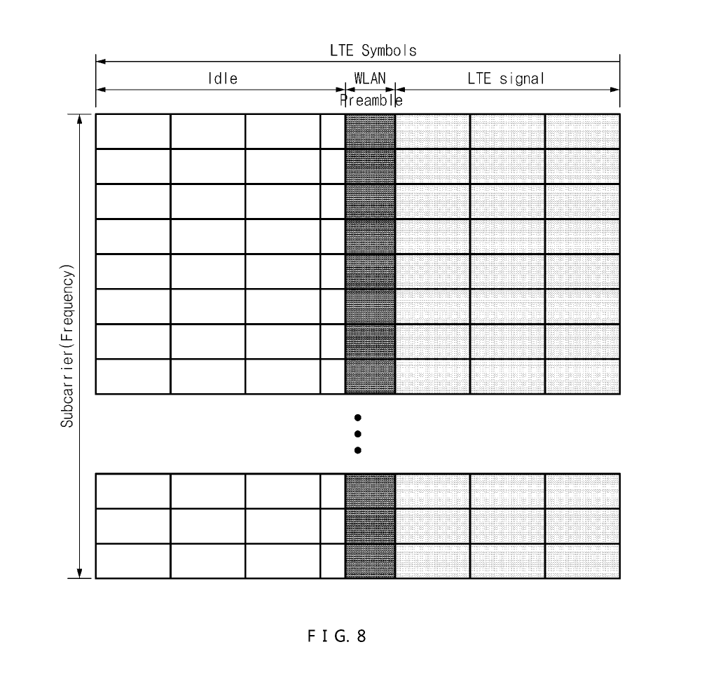

FIG. 7A is a diagram illustrating a receiver 200 structure in a communication system of a licensed band such as LTE for a co-use of a non-licensed band according to an embodiment of the present disclosure. FIG. 7B is a flowchart illustrating an operation of the receiver 200 of FIG. 7A.

Referring to FIG. 7A, the receiver 200 (e.g., eNB, UE, etc.) in a licensed band communication system such as the LTE or the like according to an embodiment of the present disclosure, may include a frame signal receiver 210, and a WLAN signal detector 220, in order to receive a transmission target signal according to protocol such as the LTE through the use of the 5 GHz non-licensed band by co-existing with the non-licensed band communication system such as the WLAN, the radar, or the like.

The frame signal receiver 210 may receive a signal transmitted from the transmitter 100 of the licensed band communication system via an antenna as shown in FIG. 6, and extract a transmission target signal according to protocol such as the LTE through a Fast Fourier Transform (FFT) processing (S210). As shown in FIG. 4 or FIG. 5, each frame of the transmission target signal may include n (natural number) (e.g., 10) sub-frames.

The WLAN signal detector 220 may extract the addition signal inserted to the start section (42/52) in front of each frame after the idle period (41/51) between frames of the transmission target signal received via the antenna (S220). The additional signal may include a certain WLAN preamble signal, and may further include reservation time (duration) information.

Accordingly, the frame signal receiver 210 may be synchronized with the transmitter 100 by using a WLAN preamble signal, and, furthermore, may receive a signal (packet) effectively by using reservation time (duration) information to demodulate (S230).

Thus, when the licensed band communication system such as the LTE or the like operates in the DFS band, it is likely to mistake the WLAN signal for the radar signal. However, in the present disclosure, the above mentioned mistake may be prevented by using the WLAN preamble signal and the reservation time (duration) information, and the influence of interference may be reduced.

FIG. 8 is a diagram illustrating location of a WLAN preamble signal of a communication method according to an embodiment of the present disclosure.

In the present disclosure, as shown in FIG. 8, a WLAN preamble signal (duration can be included) may be inserted in a start section (42/52) located in front of each frame of a transmission target signal according to the protocol such as LTE or the like. The idle period (41/51) between frames of the transmission target signal according to the protocol such as LTE or the like is a section that does not transmit any signal and the number of data symbol corresponding to idle may be selected variably between each frame of the transmission target signal.

For example, the WLAN preamble signal (duration can be included) may be located in the LTE Symbol section. The length of the WLAN preamble may be 20 μs and the WLAN preamble may be located in the LTE symbol section of about 66.7 μs. The WLAN preamble may be transmitted in the same size with the WLAN standard, and a preamble pattern may be repeatedly arranged to vary the (time) length such that the length may be set differently. The length of the WLAN preamble may be varied to be used for the sharing of the WLAN and the non-licensed band channel, which can be used to equally occupy the channel resource by the WLAN and the LTE.

According to a method and an apparatus for a communication for coexisting with a non-licensed band communication system such as WLAN, radar, or the like of a non-licensed band in a licensed band communication system such as LTE, or the like, a frame having a WLAN preamble which is inserted in a start section located in front of each frame may be transmitted and received, so that the licensed band communication system such as LTE, or the like can be better protected from the WLAN interference. In addition, in the related art, in the DFS band, the WLAN system may mistake a transmission target signal according to a protocol such as LTE, or the like for the radar signal to shift a channel such that the overall frequency utilization efficiency may be degraded. However, in the present disclosure, as the frame having a start section 42 in front of each frame to which the WLAN preamble is inserted is transmitted and received, such a mistake may be prevented in the DFS band.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A communication method for coexisting with a non-licensed band communication system of a non-licensed band in a licensed band communication system, the method comprising:
transmitting a signal by a transmitter in order to operate in a non-licensed band, when the signal is a transmission target signal having frames and a wireless local area network (WLAN) preamble signal is inserted to the front of each frame of the transmission target signal; and
extracting the WLAN preamble signal from the signal of the transmitter by a receiver to synchronize with the transmitter.

2. The communication method of claim 1, wherein the frame of the transmission target signal comprises a long term evolution (LTE) frame.

3. The communication method of claim 1, wherein the non-licensed band communication system comprises a WLAN system or a radar.

4. The communication method of claim 1, wherein the method protects from interference caused by a signal of the non-licensed band communication system.

5. The communication method of claim 1, wherein the method protects a channel shift which is accomplished as the non-licensed band communication system mistakes the transmission target signal for a radar signal in a dynamic frequency selection (DFS) band.

6. The communication method of claim 1, wherein transmitting the signal by a transmitter comprises inserting the WLAN preamble so that the WLAN preamble signal is transmitted after an idle period, when the idle period is included between frames of the transmission target signal.

7. The communication method of claim 6, wherein a length of the idle period is variably selected with respect to a length between each frame of the transmission target signal.

8. The communication method of claim 1, wherein transmitting a signal by a transmitter comprises transmitting a signal to which duration information for effectively receiving a signal during a corresponding time is inserted in addition to the WLAN preamble signal.

9. A communication apparatus for transmitting a transmission target data in a licensed band communication system in order to coexist with a non-licensed band communication system of a non-licensed band, the apparatus comprising:
a frame signal transmitter configured to generate each frame of a transmission target signal, in order to operate in the non-licensed band;
a WLAN signal generator configured to generate an additional signal including a wireless local area network (WLAN) preamble signal; and
a time synchronizer configured to control to insert the additional signal to the front of each frame of the transmission target signal.

10. The communication apparatus of claim 9, wherein the frame of the transmission target signal includes a long term evolution (LTE) frame.

11. The communication apparatus of claim 9, wherein the non-licensed band communication system includes a WLAN system or a radar.

12. The communication apparatus of claim 9, wherein an idle period is included between frames of the transmission target signal, and the time synchronizer inserts the WLAN preamble so that the WLAN preamble signal is transmitted after the idle period.

13. The communication apparatus of claim 12, wherein a length of the idle period is variably selected with respect to a length between each frame of the transmission target signal.

14. The communication apparatus of claim 9, wherein the WLAN signal generator generates the additional signal which further includes duration information for effectively receiving a signal during a corresponding time.

15. A communication apparatus for receiving a signal transmitted from a licensed band communication system in order to coexist with a non-licensed band communication system of a non-licensed band, the apparatus comprising:
a frame signal receiver configured to extract each frame of a target signal from the transmitted signal, in order to operate in the non-licensed band; and
a WLAN signal detector configured to extract an additional signal including a wireless local area network (WLAN) preamble signal which is inserted to front of each frame of the target signal from the transmitted signal,
wherein the frame signal receiver is synchronized based on the WLAN preamble signal.

16. The communication apparatus of claim 15, wherein the frame of the transmission target signal includes a long term evolution (LTE) frame.

17. The communication apparatus of claim 15, wherein the non-licensed band communication system includes a WLAN system or a radar.

18. The communication apparatus of claim 15, wherein an idle period is included between frames of the transmission target signal, and the WLAN signal detector extracts the inserted WLAN preamble after the idle period.

19. The communication apparatus of claim 18, wherein a length of the idle period is variably selected with respect to a length between each frame of the transmission target signal.

20. The communication apparatus of claim 15, wherein the additional signal further includes duration information for effectively receiving a signal during a corresponding time.
